(19) United States
(12) Patent Application Publication
(10) Pub. No.: US 2020/0111252 A1
(43) Pub. Date: Apr. 9, 2020

(54) COMPUTER STORAGE MEANS

(71) Applicant: Soletanche Freyssinet, Rueil Malmaison (FR)

(72) Inventors: Guy Perazio, Saint-Romans (FR); Gilles Hovhanessian, Antony (FR); Yohann Rabot, Antony (FR)

(73) Assignee: Soletanche Freyssinet, Rueil Malmaison (FR)

(21) Appl. No.: 16/595,653

(22) Filed: Oct. 8, 2019

(30) Foreign Application Priority Data
Oct. 9, 2018 (FR) 18 59344

(51) Int. Cl. G06T 17/05; G06F 16/51; G06T 15/08

(52) U.S. Cl. CPC G06T 17/05; G06T 2200/24; G06T 15/08; G06F 16/51

(57) ABSTRACT

Computer storage means (11) on which is stored at least one 3D digital model of at least one object, this model comprising a set of voxels modeling this object and metadata associated with the voxels, comprising at least one item of information on the accuracy with which all or part of these voxels are referenced spatially

The present invention relates generally to geographic information systems and more particularly to georeferenced 3D digital models and the uses thereof.

### STATE OF THE ART

Georeferenced digital models, particularly in an urban environment, are currently assuming an increasing importance in many practical applications. These applications include architectural design, urban and land development, or even smart towns. Digital models provide a virtual copy of reality and can thus serve as an information base for dealing with issues of town planning, or intervention on existing networks for example.

It is known practice to use satellite positioning systems to geolocate the digital acquisitions of a given environment. However, without using very costly receivers, and little-known technical methods, the accuracy is generally insufficient for many topography-linked applications.

Moreover, the reception of the GPS signal can prove difficult in certain urban environments or under plant cover.

Furthermore, it is known practice to use 2.5D geographic information systems to obtain an item of location information. This item of information is computed by combining the item of (X, Y) location information delivered by GPS and an item of altitude information Z supplied by an altimetric map such as a topographic map from the IGN. However, these systems associate the same altitude Z with each pair of coordinates (X, Y) and do not therefore guarantee that an item of information that is accurate in X, Y and Z terms is obtained.

It is also known practice to call upon a topographer in order to produce digital models of terrains or of constructed buildings. The georeferencing of these models is performed from a recording of characteristic points. The placement of these points is previously identified by the topographer. To geolocate the characteristic points, the topographer can use a theodolite, a tacheometer, a total station or a GNSS system and make use of targets placed at precise points. This operation demands the intervention of a qualified operator, and can be of a temporary nature in certain cases, for example of a work site when the targets disappear when the work ends.

The manufacturers of laser topography measurement appliances have developed robotized total stations which relieve the topographer of the target sighting operations and which save the topographic readings automatically. However, the intervention of the topographer remains necessary for the positioning of the targets.

It is also known practice to use points marked on the ground, or “Ground Control Points”, that are visible and georeferenced to realign the airborne acquisitions performed by airplane, helicopter or drone. These airborne acquisitions can be used to reconstruct a 3D mapping of an urban environment, as described in the U.S. Pat. No. 8,818,076.

The application US2015/0170368 discloses a geolocation method founded on the acquisition of images by a cellphone for example, and the search for a correlation between notable points of the images acquired by the telephone and a catalog of reference images in which these same points have been georeferenced. The method can comprise the selection on the image of the points for which geolocation is sought. Such a method depends strongly on the quality of acquisition of the images and on the capacity of the computer system to detect the corresponding reference images.

It has been proposed, in the work BIM & BTP Editions Méthodes BTP 2017, to incorporate in a digital urban model, the position of each network, in order to signal their proximity to the driver of a machine. However, as the author stresses, one difficulty stems from the lack of reliability of the final implementation files (DOEs, Dossiers d'Ouvrages Exécutés) in practice, which such a model alone cannot resolve.

There is consequently a need to facilitate the performance of works or the intervention on sites so as to make it possible to entrust these missions to less qualified operators than a topographer or facilitate the work thereof.

There are many situations in which the accurate knowledge of a given zone would make it possible to reduce the cost and the duration of the work sites in that zone.

There is also a benefit in rapidly knowing its position accurately in a given environment or accurately registering an object therein, while limiting the risks associated with the inaccuracy of the measurements.

### SUMMARY OF THE INVENTION

The invention aims to address all or some of these needs and it achieves this, according to a first of its aspects, by proposing a computer storage means on which is stored at least one 3D digital model of at least one object, this model comprising a set of voxels modeling this object and metadata associated with the voxels, comprising at least one item of information on the accuracy with which all or part of these voxels are referenced spatially.

Another subject of the invention is the method in which said 3D digital model is saved on the computer storage means, this model comprising a set of voxels modeling this object and metadata associated with the voxels, comprising at least one item of information on the accuracy with which all or part of these voxels are referenced spatially. This method can comprise the step consisting in generating the metadata associated with the voxels.

The 3D digital model and the metadata are intended to be read by a computing circuit programmed to read them.

The invention makes it possible to easily know the accuracy with which the digital model is georeferenced. Thus, an operator knowing this accuracy can take the necessary measures if the latter is insufficient to work without risk. On the other hand, if the accuracy is sufficient, the operator can be spared additional checks or measurements.

The invention proves useful for applications requiring models referenced with a good accuracy, for example better than 40 cm, better 10 cm, even better than 1 cm, particularly in the context of the performance of urban works. In effect, by virtue of the invention, it is possible to evaluate the relevance of the available 3D digital models and to use the digital model or models that have an accuracy compatible with the application considered and/or incorporate this item of information relating to the accuracy in the computation of the risks and in the decision-making process.

The invention offers the possibility of checking the location accuracy down to the voxel scale, therefore with a very fine resolution if so desired, and of enriching the digital models by identifying and/or by locally correcting the voxels for which the accuracy is below a given threshold. Ultimately, this functionality makes it possible to obtain digital models that are accurate and as close as possible to the physical reality. These digital models can be used for the performance of works on a work site, in particular works requiring a very good accuracy such as excavation works in an urban environment. For example, if a trench is likely to be dug in the roadway to access buried networks, it is desirable to be able to mark the placement of this trench and of the networks with good accuracy.

The digital models can also be used in maintenance activities in order to reduce the number of operator call-outs. As an example, in the context of the maintenance of a sewer network, the invention makes it possible to eliminate the in situ registration step since the operators can proceed with registrations and simulations directly on the digital models.

The invention can also be used to detect changes to an environment, for example modifications affecting town planning.

The invention can also be applied to driverless vehicles, which can be steered in space from the 3D digital models.

The 3D digital models stored in the storage means, unlike a 2.5D geographic information system, make it possible to take account of the modeling of all the points associated with one and the same (X, Y) pair. The 3D digital models can thus correspond to internal modelings of an object, in particular of a building, of an object in a basement or of a cavity. These modelings are difficult, even impossible, with 2.5D models.

Voxel

“Voxel” denotes a volumetric unit of a digital 3D space, preferably of cubic form. This unit can be assembled into several units by mathematical operations to create objects of different forms. The voxel can be solid or empty, which corresponds to the presence or not of matter.

Metadata

“Metadata” denotes data which are added to the geometric data necessary to the construction of the model, such as local properties, in particular of color, of texture, of transparency, or data on the corresponding materials in reality.

The metadata associated with a voxel or a set of the voxels comprise, according to the invention, at least one item of information on the accuracy with which this voxel or this set of voxels is referenced spatially.

The metadata can also comprise an item of information relating to an attribute of the object, in particular a date of creation or an updating of the datum, and/or concerning the origin of the datum and its acquisition means, which makes it possible to ensure the traceability of the data and, if necessary, to give an item of information on the reliability of the datum. In particular, the metadata can comprise a history of the different acquisitions of the data performed in one and the same zone, and concerning, for example, one and the same object.

Metadata can be associated with each voxel. However, when that is possible, there may be a benefit in saving metadata that apply to one set of voxels at a time. In this case, the additional information provided by the metadata can be known for each of the voxels of this set from access to the metadata of the set of voxels.

Storage Means

“Computer storage means” should be understood to mean any computer means making it possible to store data and execute command lines, server, a portable or desktop PC computer, tablet, smartphone or other equivalent means and storage medium such as magnetic tape, optical disk, hard disk, SSD disk, SD card or USB key.

This computer means can be connected to a network such as the Internet or a telephony network by connection or communication means.

Object

The object affected by the 3D digital model can be chosen from infrastructure elements, in particular roads, bridges, tunnels, railway lines, dams, buildings, in particular the outer and inner envelope, overhead or buried networks, street furniture and/or equipment, ships.

The object can also correspond to a district or to a town, and thus extend over more than 10 000 m² for example, even more than 1 km², even more, for example more than 10 km².

Digital 3D Models “3D digital model” should be understood to mean a set of data allowing the virtual representation of an object by means of 3D modeling software.

Such a model makes it possible to reconstruct the volume of solids by the assembly of voxels.

The 3D digital model can be obtained from data originating from an optical digital acquisition and/or resulting from a computation. The acquisition can be in the form of images and/or video sequences and/or in the form of point clouds obtained by laser scanning.

The 3D digital model can be constructed using a photogrammetry or laser scanning technique, and/or from a combined use of these two methods. The two methods of photogrammetry and of laser scanning can be coupled with voxelization techniques in order to represent the object in the form of voxels. One example of such a technique is presented in the article “Hinks, Tommy, et al. “Point cloud data conversion into solid models via point-based voxelization.” Journal of Surveying Engineering 139.2 (2012): 72-83.”

The 3D digital model can have a uniform voxel density. The voxels are then of identical size.

As a variant, the 3D digital model has a non-uniform voxel density. The 3D digital model can have regions in which the density of the voxels is strong and the relative size of the voxels relative to the dimensions of the object is small, and regions with a low voxel density, in which the voxels are of large size.

The 3D digital models can correspond to 3D models of urban zones, for example of districts, streets including buildings, the 3D digital model being able to correspond to the 3D model of an entire town.

3D digital models corresponding to objects covering an extent greater than 1 km² may thus have been saved on the storage means according to the invention.

3D digital models can be saved that correspond to objects disseminated with a density greater than 100 par km².

The 3D digital models can correspond to models of buildings for example.

The storage means according to the invention can comprise at least two 3D digital models corresponding to objects separated by a distance less than 100 m.

Accuracy Information

The item of information on the accuracy with which a voxel is referenced spatially can comprise at least one indication on the manner, relative and/or absolute, in which this accuracy is defined.

In the case where this accuracy is defined relatively, the item of information can comprise a first indication on the accuracy of relative positioning of said voxel within a subset to which the voxel belongs and a second indication on the accuracy of positioning of this subset in a reference frame (R). As an example, in the case where the object concerned is a building, the voxel can correspond to a particular point of the façade, for example a corner of a window, the subset can correspond to the window and the reference frame (R) can correspond to a local reference frame associated with the façade. The origin of the reference frame situated at the bottom of the façade for example.

That makes it possible on the one hand to better estimate the accuracy of the positioning, particularly with a view to reducing errors of positioning of the objects in the reference frame (R), and on the other hand to be able to work locally relative to a subset by having both spatial referencing relative to this subset and an estimation of the accuracy of this referencing. That can prove very useful in applications requiring a local intervention such as building restoration, notably building façades.

The position of said reference frame (R) can itself be known in another reference base (R′) and this position can be dependent on at least one quantity saved in the storage means or that can be computed from parameters entered in this storage means, in particular deformations of the ground, in particular of earth tide, oceanic overload, atmospheric overload and/or tectonic movements, linear alteration, variation of geoid type. The reference base (R′) is preferably an absolute reference base. The reference base (R′) is for example chosen from the following: Réseau Géodésique Français 1993 (RGF93), World Geodetic System (WGS84), International Terrestrial Rotational Service (ITRS) or European Terrestrial Reference System (ETRS).

The position of said reference frame (R) can be known in said reference base (R′) via a cascade of intermediate reference frames (Ri).

The accuracy with which the position of an intermediate reference frame (Ri) is known relative to at least one other reference frame (Rj) of said cascade of intermediate reference frames, can be saved in the storage means. Thus, the accuracy with which the position of said reference frame (R) is known in said reference base (R′) can be computed from the location accuracies of each of the intermediate reference frames (Rk) of said cascade of intermediate reference frames.

The benefit of this approach is that it makes it possible to have a better estimation of the positioning by taking account of the different intermediate reference frames, which enhances the accuracy of the computation of the position of the reference frame R in the absolute reference base.

The number of cascaded intermediate reference frames (Rk), whose location accuracies are preferably saved in the storage means, can be different for at least two objects referenced using these intermediate reference frames.

The storage means according to the invention can comprise 3D digital models whose voxels are georeferenced with a location accuracy better than 0.4 m in a reference base, preferably absolute, better than 0.2 m, even better than 0.1 m, in particular between 1 and 10 cm.

Yet another subject of the invention is a computer platform comprising a storage means according to the invention.

The platform can advantageously comprise a graphical interface making it possible to display the modeled object and its location accuracy, in particular in the form of at least one digital indication or of an absolute or probabilistic confidence value.

The interface makes it possible to directly access the item of information relating to accuracy, either in digital form by clicking for example on the voxel concerned, or using a graphical representation of a confidence value. The latter case is particularly advantageous since it makes it possible to easily distinguish the voxels which have a good accuracy and those which have a lesser accuracy.

The interface can also comprise a statistical processing tool which makes it possible to analyze data and can make it possible to filter according to an accuracy threshold for example.

The interface can also comprise a tool for searching for correlation between at least two 3D digital models in order to register one or more zones common to the two models.

The correlation search tool can advantageously deliver a correlation score ranging from a low value when the two models have no common zone to a high value when the two digital models corresponding to one and the same object are identical.

Another subject of the invention is a method for geolocating, notably outside, a digital acquisition tool present within a given zone, in particular an outside urban environment, this method comprising the steps consisting in:

a) performing, with the digital tool, at least one acquisition of its environment,

b) identifying, by a technique of correlation between the acquired data and 3D digital models, at least one 3D digital model of at least one object of said zone, this model being stored in a storage means according to the invention,

c) computing, from this identification and/or from the manner in which said 3D digital model is perceived by the tool, the coordinates and the orientation of the digital tool in a reference base, preferably absolute.

By virtue of the invention, once the digital tool is located, the latter can be used for various operations, such as, for example, acquiring a point cloud in order to obtain a 3D digital model of the environment of the tool, observing an evolution of this environment by comparison with a modeling previously performed, or locating given points of interest, present in the environment of the tool.

In addition to the location of the tool, it is possible to deliver an item of information of the geolocation accuracy thereof. The latter can be obtained from at least one item of information on the accuracy with which all or part of the voxels of the 3D digital models used for the identification are referenced spatially.

Yet another subject of the present invention is a method for geolocation, in particular outside, of a digital acquisition of a given zone performed with a digital acquisition tool, this method comprising the steps consisting in:

a′) identifying, by a technique of correlation between the acquired data and 3D digital models, at least one 3D digital model of at least one object of said zone, this model being stored in a storage means according to the invention,

b′) geolocating said digital acquisition from this identification.

The method can also comprise a step consisting in delivering an item of information on the geolocation accuracy of the tool, computed from at least one item of information on the accuracy with which all or part of the voxels of the 3D digital model used for the identification are referenced spatially.

Digital Tool

“Digital tool” denotes any system that makes it possible to implement the method according to the invention and in particular to acquire spatial information on a given environment. The tool makes it possible to perform an acquisition of its environment that makes it possible to generate a 3D digital model thereof.

The digital tool can benefit from communication means allowing it to interrogate the storage means according to the invention. As a variant, the tool has the memory needed to store the information of said base, or at least a part thereof.

The tool can comprise a processor allowing it to perform at least a part of the processing of the above step c). At least a part of the processing and of the computations can be transferred to a remote server, for example incorporated in the digital platform according to the invention, with which the tool can be connected.

The tool can comprise a range-finding system. The tool can comprise any element known among laser scanning or photogrammetry devices. The tool can comprise at least one photo or video sensor for acquiring information in the form of images or one or more laser scanners, static, for example LEICA BLK360, Z+F IMAGER 5010C or FARO FOCUS, or dynamic, such as LEICA PEGASUS 2.0 or LEICA BACKPACK making it possible to acquire the information in the form of point clouds. The laser scanner can advantageously be associated with a photo or video sensor. The tool can comprise a scanner of LIDAR type.

Advantageously, the digital tool is associated with a GPS making it possible to provide the coordinates of the acquired data. The tool can comprise a laser aiming system making it possible to point the tool to a geolocated element or to a point of interest whose position is desired to be known in the absolute reference base. The digital tool can thus comprise a laser and at least one camera. The laser can assist in aiming at a point of interest and the camera can be used to read the data present on the element or to acquire an image of its immediate environment.

The tool can comprise a tripod and an articulation making it possible to orient it in azimuth and in elevation.

The tool can also comprise a system capable of reading an item of information specific to an element providing an additional item of positioning information, if necessary.

Zone

The zone concerned is preferably an outside urban zone, comprising, for example, buildings such as apartment or office blocks, individual houses, street furniture such as street lights, dipped headlights, traffic signs, advertising hoardings, shelters or benches, among other things.

The zone can even be inside a building.

The zone can also be an underground zone.

Acquisition of the Environment of the Tool

“Acquisition of the environment of the tool” should be understood to mean a recording of spatial data. The acquisition of the spatial data can be performed for example in the form of data from sets of images or video sequences, or in the form of point clouds.

The acquisition can be performed with at least one rotation of the tool on itself about an axis of rotation, preferably fixed throughout this rotation, or using several sensors having different aiming axes.

The acquisition can be performed with the tool moving during said acquisition.

The acquisition can be performed using at least one camera, equipped with a telescope for example.

The identification in the step b) and/or in the step a′) can involve at least one additional item of positioning information. This additional item of location information can comprise the position of the tool as supplied by a satellite geolocation system, preferably standard and inexpensive or an item of geolocation information as supplied by a mobile telephony network. The additional item of location information can thus have an accuracy of location in the reference base lower than that associated with the voxels of one or more of the 3D digital models listed in the storage means from which the identification in step b) and/or the step b′) is performed. The accuracy of location of the additional item of information can in particular be worse than 1 m.

This item of information makes it possible to perform a first selection from among the reference 3D digital models available in the storage means, to have the identification focus only on a set of 3D digital models geographically close to the acquisition and/or tool. That makes it possible to reduce the processing time, since the search for correlation is thus ultimately performed only on a limited selection of 3D digital models.

The additional item of information can also be provided by a registration element present in the environment of the tool, this element being, for example, individually identifiable and the bearer of identification data that can be read by the tool. This element can be geolocated accurately or not.

The acquisition of the environment being performed by remote laser detection and/or by video.

The method can comprise an additional step d) and/or c′) in which the digital model corresponding to the digital acquisition geolocated in the step c) and/or b′) is scaled from the reference 3D digital model.

“To scale” should be understood to mean a method aiming to establish a metric correlation between the 3D digital model and the object for which modeling is sought.

The scaling can correspond to registering points common between the 3D digital model and the reference model, to computing the distance between these points both in the reference model and in the 3D digital model, to computing the scaling ratio then applying it to the 3D digital model.

The scaling can be performed automatically with software known to the person skilled in the art, such as Blender or Autodesk for example.

As a variant, it can be performed semi-automatically.

Enrichment of the Storage Means

The method can further comprise an additional step e) and/or d′) in which the digital model corresponding to the digital acquisition geolocated in the step c) and/or b′), and an item of information relating to the accuracy of location of this model, are stored in the storage means.

This step thus makes it possible to enrich the storage means by adding thereto the new digital model generated from the digital acquisition. This step also makes it possible to update the existing 3D models, either by replacing the voxels of the reference models that have poor accuracy with voxels of the new digital model, or by locally refining the density of voxels. Finally, when objects have appeared or have disappeared between two acquisitions, it is possible to add or delete them to or from the old 3D model.

The updating of the existing digital models is preferably accompanied by the storage in the storage means of the date of the new acquisition, its origin and its accuracy. Thus, it is possible to access, for one and the same zone, the history of the different acquisitions which have been made. This history thus makes it possible to have 4D data.

The 3D digital models may not be fixed in time. Their evolution can be indicated, for example by display on a screen or on a printout, using displacement vectors associated with all or part of their voxels. The displacement vector associated with a voxel of a 3D digital model can be a function of time. This vector can be computed by comparing the coordinates of the voxel stored over time in the history of the acquisitions. The displacement vector can thus be used to detect changes to an environment, for example modifications impacting town planning. The method can thus comprise a step consisting in comparing two 3D models of the same object over time and generating, from this comparison, a file giving information on the changing of the position of certain voxels from one model to another.

Yet another subject of the invention is a method for constructing a 3D digital model comprising the steps consisting in:
proceeding with at least one digital acquisition of at least one geolocated object,
saving, in a storage means according to the invention, an item of information relating to the accuracy of location of the digital acquisition or acquisitions,
generating, from this or these acquisitions, at least one 3D digital model,
assigning, to at least one voxel of this 3D model, an item of information relating to the location accuracy thereof.
saving this georeferenced 3D digital model in the storage means.

### BRIEF DESCRIPTION OF THE FIGURES

The invention will be able to be better understood on reading the following detailed description of nonlimiting examples of implementation thereof, and on studying the attached drawing, in which:

FIGS. 1a to 1f illustrate an example method of constructing a georeferenced 3D digital model according to the invention,

FIG. 2 is a block diagram illustrating an example geolocation method according to the invention,

FIG. 3 is a block diagram relating to the identification processing performed,

FIG. 4 illustrates the acquisition of an object,

FIGS. 5a and 5b illustrate an example use of a cascade of reference frames, and

FIGS. 6a and 6b illustrate example of displays of a modeled object with an item of information relating to the accuracy of location of the voxels.

### DETAILED DESCRIPTION

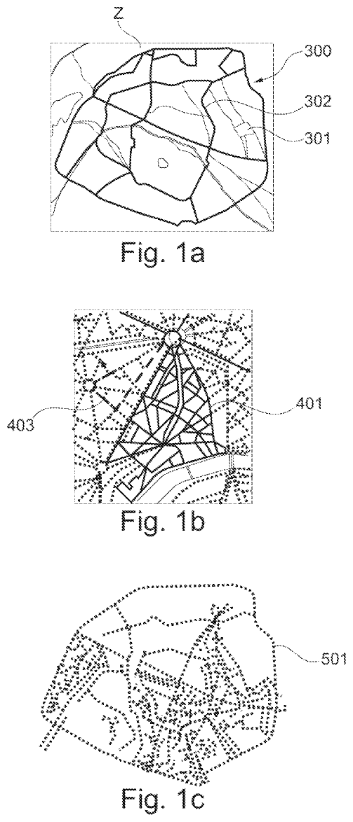

FIGS. 1a to 1f illustrate an example method of constructing a 3D digital model according to the invention.

According to one aspect of the invention, an acquisition is performed in one or more zones Z, preferably on land, for example in one or more towns, along roads or on works or infrastructures of all kinds.

In the example of FIG. 1a, the zone Z is a town. The acquisition is performed in two phases. Firstly, a reference meshing of the zone is constructed so as to generate a reference mesh 300. This mesh makes it possible to define the geographic limits of the acquisition and divide the zone up into intervention sectors 301. The reference mesh 300 can also be used as working base, on which the itineries completed and the sectors which remain to be read can be logged and viewed. FIG. 1b illustrates an example superimposition of itineraries already completed 401 on the map and a current itinerary 403.

Secondly, a digital acquisition of the sectors 301 is performed using one or more digital tools 20 as illustrated in FIG. 1d. In the example of FIG. 1d, the sector 301 is a district comprising a street with furniture B. These tools can comprise any element known for this purpose, such as laser scanning and/or photogrammetry devices. They can correspond to mobile acquisition systems such as LEICA PEGASUS 2.0 and/or LEICA BACKPACK, or static acquisition systems such as LEICA BLK360, Z+F IMAGER 5010C and/or FARO FOCUS. Preferably, the acquisition is performed jointly using at least one static tool and at least one mobile tool. Advantageously, the digital tools are associated with a satellite location system, for example GPS, making it possible to provide the coordinates of the acquired data and an item of information on the location accuracy of the data. Preferably, one or more fixed GPS antennas, such as, for example, LEICA AS10 GPS and/or a LEICA GS15 GPS are also installed at different points of the zone Z.

Preferably, GPS control points 501 are disseminated in the zone Z. In the example illustrated in FIG. 1c, the number of control points is approximately 200 points. These control points make it possible to both validate the locations of the data from the acquisition and to compensate them in case of deviation. These points also make it possible to validate the location accuracy of the data from the acquisition.

The acquisition can be done by sector 301, in particular by district or borough. The itineraries followed during the acquisition are preferably constructed so as to overlap to have control points at the intersections. Furthermore, the intersections obtained make it possible to obtain information on the location accuracy of the data from the acquisition. Preferably, the itineraries are performed in both directions on the axes separating the different sectors of the reference mesh. Preferably, the acquisitions are attached to the “reference” mesh and their itineraries are represented on this mesh. The acquisition described above aims to generate 3D digital models of the zone through processing of the data. Preferably, the latter are point clouds obtained by remote laser detection. Advantageously, the acquisition also comprises the taking of several photos and/or video sequences. The latter can make it possible to add texture to the point cloud.

In addition to the location of the data, the acquisition described above also makes it possible to obtain an item of information on the accuracy of location of these data.

The acquisition can, if necessary, be performed by a human operator or by an automatic device. It can include aerial acquisitions, performed for example by a drone.

The acquisitions of one and the same object of a sector 301 of the zone Z can comprise several points of view and be performed from different positions.

FIG. 1e illustrates an example of a point cloud obtained after the acquisition of a building B1 of the sector 301 of FIG. 1d with a laser scanner.

Geolocated elements 21 can be arranged in the environment forming the subject of the acquisition to assist in geolocating the 3D digital models obtained.

The data are then transmitted to a platform 1 for example. The latter can comprise, as illustrated, an interface 10 with which the tool 20 can exchange these data, for example via a telecommunication network 30 such as the GPRS network or the 3G or 4G network and a storage means 11 in which these data are stored. In addition to the coordinates of the data, metadata can be saved, such as the location accuracy thereof, the date on which these data were acquired, the references of the sector of the acquisition, in particular its name, the references of the acquisition tool.

The processing of the data from the acquisition can be performed from point cloud processing software, for example RealWorks 10 for the static acquisitions or LEICA PEGASUS Manager for the dynamic acquisitions.

To generate a 3D digital model, a stereovision algorithm can be used, which exploits measurements, photos or point clouds, produced with at least two different points of view. The algorithm can compare the relative positions of the points of the object that are identifiable on the different points of view. The algorithm can also exploit texture elements to improve the quality of the 3D reconstruction.

The algorithm is coupled with a voxelization technique to obtain a digital model in the form of voxels.

FIG. 1f represents an example 3D digital model of the building B1 obtained after transformation of the point cloud of FIG. 1e into voxels 50.

Each 3D digital model can be stored in the storage means 11 to serve as geolocated reference 3D model and associated with metadata such as the accuracy with which all or part of its constituent voxels are spatially referenced and/or the date on which the data used to generate the 3D model were acquired.

The storage means 11 can provide a catalog of geolocated 3D digital models serving as reference, within a given zone of interest, that can be used for registration in the zone using a digital tool.

Depending on the accuracy of the geolocated 3D digital models, the latter can be used in different contexts, for example the geolocation of a digital tool and/or a digital acquisition performed by this tool.

The location accuracy of a voxel can be computed relative to any reference base, local or absolute, as will be detailed later.

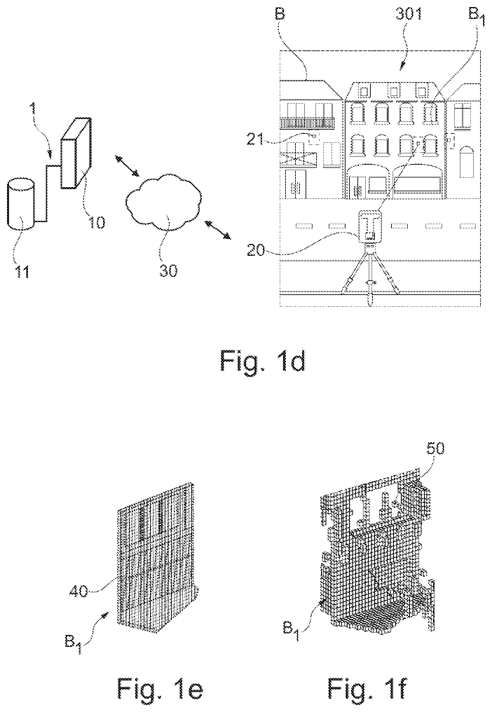

FIGS. 2 to 4 illustrate a geolocation method in an environment of the zone Z using the information available in the computer storage means according to the invention.

In the steps 100, 101 and 102, a digital acquisition is performed using any digital tool 20, one or more 3D digital models are generated and the models are stored in the storage means together with metadata such as an item of information on the accuracy with which all or part of the data used to generate the 3D models are referenced, the date of acquisition of these data and the references of the sector, as explained above in the example of FIGS. 1a-f.

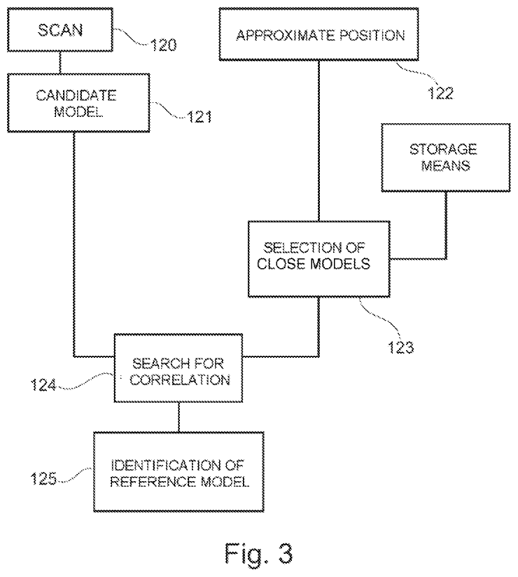

In the step 103, an acquisition of data of all or part of an environment of the zone Z in which geolocation is sought is performed with a digital tool 150, as illustrated in FIG. 4. In this example, the digital tool is used to perform an acquisition of a façade of a building B2 of a sector 301 of the zone Z.

The data are then transmitted to the platform 1 via the interface 10 with which the tool 20 can exchange. These data are then used to generate a 3D digital model, called candidate, through a modeling process which can be similar to that of the step 101.

In order to geolocate the candidate digital model, in the step 105, a correlation tool is used to identify the reference 3D digital model from the storage means 11 which is best correlated with the candidate digital model. This is for example a geolocated 3D digital model of the same building B2, previously produced by an acquisition of the building by laser scanning by a topographer for example.

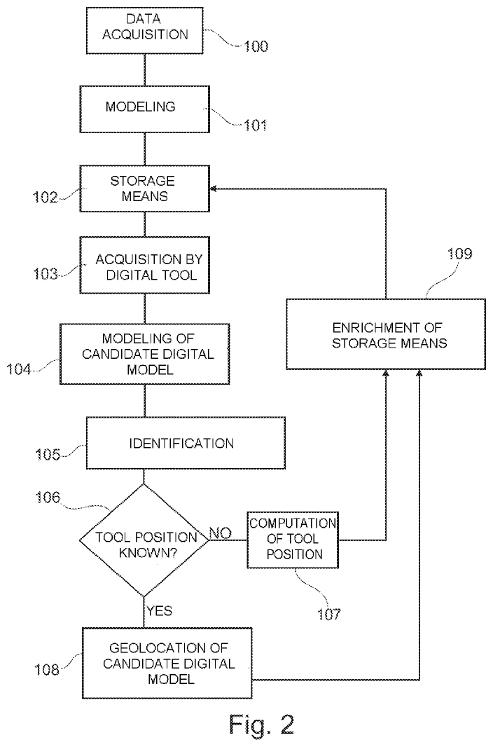

The reference digital model can in particular be identified by following the steps illustrated in FIG. 3. Firstly, an item of information provided in the step 122 through the knowledge of the approximate position of the digital tool 150 can be used. This item of information can be supplied by a satellite geolocation system, preferably standard and inexpensive or an item of geolocation information as supplied by a mobile telephony network. This item of information makes it possible to perform, in the step 123, a first selection from among the reference 3D digital models available in the storage means 102, to have the identification focus only on a set of 3D digital models geographically close to the candidate model. This step makes it possible to reduce the processing time, since the search for correlation of the step 124 is thus performed ultimately only on a limited selection of 3D digital models. The selection of the reference 3D digital models can also be performed by indicating a reference of the sector containing the building B2, in particular the name of the district or of the street. That makes it possible to perform a search of the 3D models which are in the same sector by using the metadata provided for this purpose previously saved in the storage means 11.

This search for correlation by the correlation tool can be performed for example using a neural network trained to recognize a 3D digital model from a scan or from any optimization algorithm, for example using least squares.

It is possible to determine one or more reference geometrical forms common to both the candidate model and the reference model, and the corresponding georeferenced locations are identified.

The knowledge of these locations can make it possible to geolocate, in the step 108, the candidate 3D digital model, such that the coordinates, in particular geodesic, of each point of this model can be obtained in a reference base, preferably absolute. Furthermore, the knowledge of the location of the common characteristics can make it possible to compute the position of the tool in the step 107 when the latter is unknown, for example by using geometrical methods. In addition to the location coordinates, it is possible to obtain the location accuracy as well as the date on which the 3D digital model and/or the digital tool were geolocated.

Finally, this method can also comprise a step 109 of storage of the candidate 3D digital model, with information concerning the location and the location accuracy of certain characteristic points, in the storage means 102, to enrich the latter.

The location accuracy of a voxel can be computed relative to any reference base, local or absolute. In particular, this accuracy can be computed by using a cascade of intermediate reference frames each registered with a specific location accuracy.

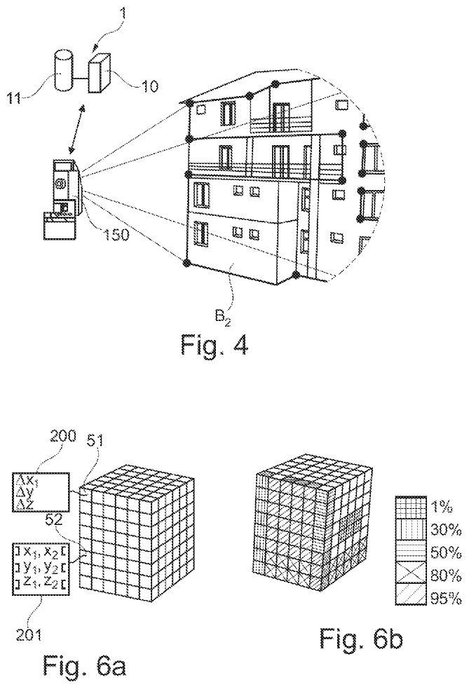

FIGS. 5a and 5b illustrate an example use of a cascade of reference frames according to the invention in which the aim is to compute the location accuracy of the voxel v₁ relative to the reference frame (R₂) by using two intermediate reference frames (R₀) and (R₁).

In this example, the location of the voxel v₁ is known in the reference frame (R₀) with an accuracy Δₓ_{ᵥ₁}, Δ_{y}_{ᵥ₁} and Δ_{z}_{ᵥ₁} respectively in the three directions x, y and z. The reference frame (R₀) is itself located in the reference frame (R₁) with an accuracy Δₓ_{₀₁}, Δ_{y}_{₀₁} and Δ_{z}_{₀₁} and the position of the reference frame (R₁) is known in the reference frame (R₂) with an accuracy Δₓ_{₁₂}, Δ_{y}_{₁₂} and Δ_{z}_{₁₂}. Finally, the position of the reference frame (R₂), which is for example an absolute reference base, is itself known with an accuracy Δₓ_{₂}, Δ_{y}_{₂} and Δ_{z}_{₂}. This accuracy takes account of a certain number of phenomena which impact the position of the center of this reference frame, in particular the deformations of the ground, in particular of earth tide, oceanic overload, atmospheric overload and/or tectonic movements, linear alteration, variation of the geoid type. This information is previously recorded in the storage means 11. FIG. 5b represents an example recording of the data concerning the voxel v₁ in the form of a table. The latter comprises the coordinates of the voxel v₁ in the reference frame (R₀) and the accuracy with which this voxel is located and the date of creation of the datum.

This approach thus makes it possible, at any moment, to compute the accuracy of location of a voxel and/or of a reference frame of the cascade relative to another reference frame thereof.

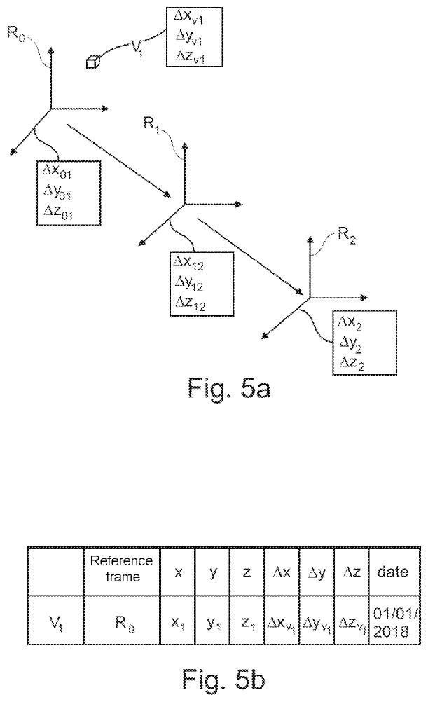

FIGS. 6a and 6b show example displays of a modeled object with an item of information relating to the location accuracy of the voxels.

FIG. 6a illustrates an example display of the item of information on the accuracy in digital form or in the form of an absolute confidence value. This item of information is displayed in the windows 200 and 201 by clicking on the voxels 51 and 52 for example. The absolute confidence value can correspond to a range of position values that can contain the true position of the voxel, as displayed in the window 201.

In FIG. 6b, the platform 1 makes it possible to accompany the 3D digital model with a probabilistic confidence value that makes it possible to visually check the level of uncertainties associated with the accuracy of the location of the voxels. In this example, each level of uncertainties has associated with it a color belonging for example to a color scale. Thus, the voxels that have the same level of uncertainties are displayed with the same color. This display can be accompanied by a legend 250. It is also possible to filter the voxels to display only the voxels that possess a level of uncertainty above or below a given threshold. FIG. 6b shows the probability of the accuracy of the location of the voxel being less than 1 cm.

Obviously, the invention is not limited to the examples described. The 3D models are not limited to the outside representation of the objects and apply also to the interior of the objects for example.

The expression “comprising a” should be understood with its usual meaning as being synonymous with “comprising at least one”.

1. Computer storage means on which is stored at least one 3D digital model of at least one object, this model comprising a set of voxels modeling this object and metadata associated with the voxels, comprising at least one item of information on the accuracy with which all or part of these voxels are referenced spatially.

2. Means according to claim 1, the item of information on the accuracy with which a voxel is referenced spatially comprising at least one indication on the manner, relative and/or absolute, in which this accuracy is defined.

3. Means according to claim 1, the item of information on the accuracy with which a voxel is referenced spatially comprising a first indication on the accuracy of relative positioning of said voxel within a subset to which the voxel belongs and a second indication on the accuracy of positioning of this subset in a reference frame (R).

4. Means according to claim 3, the position of said reference frame (R) being itself known in another reference base (R′) and this position being dependent on at least one quantity stored in the storage means or that can be computed from parameters entered in this storage means.

5. Means according to claim 4, the position of said reference frame (R) being known in said reference base (R′) via a cascade of intermediate reference frames (Ri).

6. Means according to claim 5, the accuracy with which the position of an intermediate reference frame (Ri) is known relative to at least one other reference frame (Rj) of said cascade of intermediate reference frames being stored in the storage means.

7. Means according to claim 5, the accuracy with which the position of said reference frame (R) is known in said reference base (R′) being computed from location accuracies of each of the intermediate reference frames (Rk) of said cascade of intermediate reference frames.

8. Means according to claim 5, the number of cascaded intermediate reference frames (Rk) being different for at least two objects referenced using these intermediate reference frames.

9. Means according to claim 1, the object being chosen from infrastructure elements, bridges, tunnels, railway lines, dams, buildings, street furniture and/or equipment, ships.

10. Means according to claim 1, the metadata associated with the voxels further comprising an item of information relating to an attribute of the object and/or to a date, and/or concerning the origin of the datum and its acquisition means.

11. Means according to claim 1, comprising:
3D digital models corresponding to objects or scenes covering an extent greater than 1 km²,
3D digital models corresponding to objects or scenes disseminated with a density greater than 100 per km²,
at least two 3D digital models corresponding to objects separated by a distance less than 100 m, and/or
3D digital models whose voxels are georeferenced with a location accuracy better than 0.4 m in a reference base.

12. Computer platform comprising a storage means according to claim 1.

13. Platform according to claim 12, comprising a graphical interface making it possible to display the modeled object and its location accuracy.

14. Method for geolocating a digital acquisition tool present within a given zone, this method comprising steps consisting in:
a) performing, with the digital tool, at least one acquisition of its environment,
b) identifying, by a technique of correlation between the acquired data and 3D digital models, at least one 3D digital model of at least one object of said zone, this model being stored in a storage means according to claim 1,
c) computing, from this identification and/or from the manner in which said 3D digital model is perceived by the tool, the coordinates of the digital tool in a reference base.

15. Method for geolocating a digital acquisition of a given zone performed with a digital acquisition tool, this method comprising the steps consisting in:
a′) identifying, by a technique of correlation between the acquired data and the 3D digital models, at least one 3D digital model of at least one object of said zone, this model being stored in a storage means according to claim 1,
b′) geolocating said digital acquisition from this identification.

16. Method according to claim 14, in which there is delivered:
an item of information on the geolocation accuracy of the tool, computed obtained from at least one item of information on the accuracy with which all or part of the voxels of the 3D digital model are referenced spatially, and/or
an item of information on the geolocation accuracy of the digital acquisition, computed obtained from at least one item of information on the accuracy with which all or part of the voxels of the 3D digital model are referenced spatially.

17. Method according to claim 14, the identification in the step b) and/or in the step a′) involving at least one additional item of positioning information.

18. Method according to claim 17, the additional item of location information having a location accuracy in the reference base (R′) less than that associated with the voxels of one or more of the 3D digital models listed in the storage means from which the identification in the step b) and/or the step b′) is performed.

19. Method according to claim 14, a 3D digital model being generated from the digital acquisition geolocated in the step c).

20. Method according to claim 19, comprising an additional step d) and/or c′) in which the 3D digital model deriving from the digital acquisition geolocated in the step c).

21. Method according to claim 14, the digital acquisition being performed by remote laser detection or by photogrammetry.

22. Method according to claim 14, the 3D digital model deriving from the digital acquisition being scaled from the digital model stored in the storage means.

23. Method for constructing a 3D digital model comprising the steps consisting in:
proceeding with at least one digital acquisition of at least one geolocated object,
saving, in a storage means according to claim 1, an item of information relating to the accuracy of location of the digital acquisition or acquisitions,
generating, from this or these acquisitions, at least one 3D digital model,
assigning to at least one voxel of this 3D model an item of information relating to its accuracy of location thereof,
saving this georeferenced 3D digital model in the storage means.
